(19) United States
(12) Patent Application Publication
(10) Pub. No.: US 2026/0179924 A1
(43) Pub. Date: Jun. 25, 2026

(54) POSITIVE ELECTRODE ACTIVE MATERIAL, METHOD FOR MANUFACTURING THE SAME, POSITIVE ELECTRODE COMPRISING THE SAME, AND LITHIUM SECONDARY BATTERY COMPRISING THE SAME

(71) Applicants: HYUNDAI MOTOR COMPANY, Seoul (KR); KIA CORPORATION, Seoul (KR); Industry Academic Cooperation Foundation of KyungHee University, Yongin-si (KR)

(72) Inventors: Sooyoung Yang, Hwaseong-si (KR); Changhoon Song, Hwaseong-si (KR); Taeho Park, Hwaseong-si (KR); Eungju Lee, Hwaseong-si (KR); Dowook Jun, Hwaseong-si (KR); Seung-Min Oh, Hwaseong-si (KR); Duckgun Mok, Hwaseong-si (KR); Dongil Kim, Ulsan (KR); Jaewoo Jung, Yongin-si (KR); Seong-Hee Jeong, Ansan-si (KR); Min-Sik Park, Seoul (KR)

(73) Assignees: HYUNDAI MOTOR COMPANY, Seoul (KR); KIA CORPORATION, Seoul (KR); Industry Academic Cooperation Foundation of KyungHee University, Yongin-si (KR)

(21) Appl. No.: 19/169,471

(22) Filed: Apr. 3, 2025

(30) Foreign Application Priority Data
Dec. 24, 2024 (KR) 10-2024-0195273

(51) Int. Cl. H01M 4/36; C01G 53/42; H01M 4/485; H01M 4/525; H01M 10/052

(52) U.S. Cl. CPC H01M 4/366; C01G 53/42; H01M 4/485; H01M 4/525; H01M 10/052; C01P 2002/72; C01P 2002/82; C01P 2002/85; C01P 2004/03; C01P 2004/04; C01P 2004/84; C01P 2006/40

(57) ABSTRACT

A positive electrode active material comprising a coating portion with excellent conductivity, a method for manufacturing the same, a positive electrode comprising the same, and a lithium secondary battery comprising the same.

### CROSS-REFERENCE TO RELATED APPLICATION

This present application claims the benefit of priority to Korean Patent Application No. 10-2024-0195273, entitled “POSITIVE ELECTRODE ACTIVE MATERIAL, METHOD FOR MANUFACTURING THE SAME, POSITIVE ELECTRODE COMPRISING THE SAME, AND LITHIUM SECONDARY BATTERY COMPRISING THE SAME” filed on Dec. 24, 2024, in the Korean Intellectual Property Office, the entire disclosure of which is incorporated herein by reference.

### FIELD

The present disclosure relates to a positive electrode active material comprising a coating portion with excellent conductivity, a method for manufacturing the same, a positive electrode comprising the same, and a lithium secondary battery comprising the same.

### BACKGROUND

As a negative electrode active material for a lithium secondary battery, a graphite-based negative electrode material capable of intercalation and deintercalation of lithium ions is mainly used. Although the graphite-based negative electrode material has strengths in stability and life characteristics, there is a limitation in next-generation battery technology that requires high energy density due to a low theoretical capacity of 372 mAh/g. To overcome this problem, research on high-capacity negative electrode materials such as transition metal oxide or silicon-based negative electrode materials has been actively conducted. Although these materials may provide much higher theoretical capacity than graphite-based negative electrode materials, these materials have the disadvantage of showing a high irreversible capacity loss during initial charging. As a result, about 30% of the lithium ions of the positive electrode active material used for the first charge do not contribute to charging and discharging.

To overcome this irreversible capacity loss problem, a pre-lithiation technique has been proposed. Briefly, pre-lithiation is a method of improving the performance of a negative electrode by compensating for an irreversible loss at the initial charging by, for example, utilizing positive electrode additives or similar technology. Such positive electrode additives may be easily integrated into a conventional battery manufacturing process and are advantageous in increasing the stability of the electrode by compensating for the initial irreversible capacity. One specific method supplements lithium ions through the use of a large amount (excess) of lithium in positive electrode active material.

However, positive electrode active material that contains excessive lithium can easily react with moisture or carbon dioxide in air and form impurities such as Li₂CO₃ and LiOH on the particle surface. The residual lithium formed on the surface above causes side reactions with an electrolyte, which can cause gas generation and a decrease in electrochemical performance.

To solve this problem, research has been conducted to coat positive electrode active material particles with metal oxides. Metal oxide coatings can be effective in maintaining the electrochemical performance of the positive electrode active material by improving air stability.

However, since metal oxides generally have insulating properties with low ionic conductivity and electronic conductivity, metal oxides coated on the positive electrode active materials can cause problems such as reduced charge transfer on the surface and increased interfacial resistance.

Given these various approaches, it has been difficult to develop an optimal positive electrode additive. As described herein, modifications and improvements in positive electrode active material technologies can simultaneously provide for stability against the surrounding environment conditions, as well as maintain electrochemical performance.

### SUMMARY

The present disclosure addresses a number of the above-described problems in the state of the art, and in a general aspect, provides a positive electrode active material with excellent electrochemical performance by coating the surface of the positive electrode active material with a coating material having excellent ionic and electronic conductivity to reduce interfacial resistance and improve air stability. Also provided is a method for manufacturing the same, a positive electrode comprising the same, and a lithium secondary battery comprising the same, among other aspects, embodiments, and features.

In these aspects and embodiments, the present disclosure provides a method for manufacturing a positive electrode active material that may comprise obtaining a core particle comprising lithium metal oxide, obtaining a coating material comprising a compound represented by Chemical Formula 1, and coating the surface of the core particle with the coating material.

Chemical Formula 1 comprises:

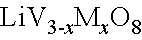

wherein, x is 0≤x≤1.5, and M is at least one of Nb, Ta, Cr, As, Mo, Sb, and/or Bi. In embodiments, M can be selected from the group consisting of Nb, Ta, Cr, As, Mo, Sb, and Bi.

In embodiments, a positive electrode active material according to the present disclosure may comprise a core portion comprising lithium metal oxide, and a coating portion formed on the surface of the core portion and comprising the compound represented by Chemical Formula 1.

A positive electrode according to an embodiment of the present disclosure may comprise a positive electrode active material according to various embodiments of the present disclosure, a conductive material, and a binder.

A lithium secondary battery according to an embodiment of the present disclosure may comprise a positive electrode according to various embodiments of the present disclosure.

According to the present disclosure, the positive electrode active material comprises a coating portion, thereby improving air stability.

Through the materials and methods provided herein, it is possible to prevent or suppress the formation of impurities such as residual lithium when compared to the state of the art.

Through the materials and methods provided herein, it is possible to significantly reduce or prevent the amount of gas generated by side reactions between impurities and an electrolyte when compared to the state of the art.

In additional embodiments, the positive electrode active material according to the present disclosure may prevent or suppress side reactions with the electrolyte as described herein, thereby preventing a decrease in capacity when compared to the state of the art.

Aspects and embodiments of the positive electrode active material according to the present disclosure comprise a coating portion having excellent ionic conductivity and electronic conductivity, thereby reducing interfacial resistance. As such, the materials and methods provided herein makes it possible to improve ionic conductivity and electronic conductivity and exhibit excellent electrochemical characteristics.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a schematic diagram schematically showing a positive electrode active material according to an embodiment of the present disclosure;

FIG. 2 shows schematically a chemical structure of a coating portion according to an embodiment of the present disclosure;

FIG. 3 shows results of X-ray diffraction analysis for Comparative Examples 2 and 3;

FIG. 4 shows results of X-ray diffraction analysis for Comparative Example 1 and Examples 1 to 4;

FIG. 5 shows results of Raman spectrum analysis for Comparative Example 1 and Examples 1 to 4;

FIG. 6 shows results of X-ray photoelectron spectroscopy (XPS) analysis for V 2p regions of Comparative Example 1 and Examples 1 to 4;

FIG. 7 shows results of X-ray photoelectron spectroscopy (XPS) analysis for Nb 3d regions of Comparative Example 1 and Examples 1 to 4;

FIG. 8 shows results of X-ray photoelectron spectroscopy (XPS) analysis for Li 1s regions of Comparative Example 1 and Examples 1 to 2;

FIG. 9 shows SEM images of Comparative Example 1 and Examples 1 to 4;

FIG. 10 shows an EDS mapping image for Example 2;

FIG. 11 shows a TEM image of a positive electrode active material of Example 2 and analysis results of an interplanar distance calculated based on the TEM image. Panel (a) shows a TEM image of Example 2 observed at a relatively low magnification; panel (b) shows a TEM image of Example 2 observed at a relatively high magnification; and panel (c) shows a result of measuring the interplanar distance between a core portion and a coating portion based on panel (b);

FIG. 12 shows results of impedance analysis for Comparative Example 1 and Examples 1 to 4;

FIG. 13 shows results of capacity analysis for Comparative Example 1 and Examples 1 to 4;

FIG. 14 shows results of X-ray diffraction analysis of Comparative Example 1 and Examples 1 to 4 after exposure to air for 24 hours at a relative humidity of 40%;

FIG. 15 shows results of measuring residual lithium (LiOH, Li₂CO₃) through electrochemical titration in Comparative Example 1 and Examples 1 to 4 after exposure to air for 24 hours at a relative humidity of 40%; and

FIG. 16 shows results of gas generation analysis for Comparative Example 1 and Example 2.

### DETAILED DESCRIPTION

Unless defined otherwise by the disclosure, all technical and scientific terms used herein should be given their ordinary and customary meaning as commonly understood by one of ordinary skill in the art to which the disclosure belongs. A number of terms and abbreviations appear throughout the disclosure and, unless otherwise defined or indicated, should be understood to have their reasonably broad commonly understood and plain meanings that are consistent with the context in which the terms are used.

As used herein, referent terms such as “first,” “second,” “initial,” “subsequent,” and the like, may be used for describing various components, but the components are not limited by the terms. These terms are only used to distinguish one component from another component. For example, without departing from the scope of the present disclosure, a first component may be named as a second component, and similarly, a second component may be named as a first component.

The terms used herein describe particular example embodiments only and are not intended to limit the present disclosure. A singular expression includes a plural expression unless otherwise defined differently in a context. In the present disclosure, it should be understood that term “comprising” or “having” or “including” indicates that a feature, a number, a step, an operation, a component, a part or a combination thereof described in the specification is present, but does not exclude a possibility of presence or addition of one or more other features, numbers, steps, operations, components, parts or combinations thereof, in advance. It will be appreciated that those terms are also inclusive of the term “consisting of” or “consisting essentially of” which, when used throughout the disclosure or claims, generally indicate that a feature, a number, a step, an operation, a component, a part or a combination thereof described in the specification is present, and does not include any additional feature(s).

In an aspect, a method for manufacturing a positive electrode active material in accordance with the disclosure may comprise obtaining a core particle comprising lithium metal oxide, obtaining a coating material comprising a compound of Chemical Formula 1, and coating the surface of the core particle with the coating material, wherein.

Chemical Formula 1 comprises:

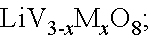

wherein, x is 0≤x≤1.5, and Mis at least one of Nb, Ta, Cr, As, Mo, Sb, and/or Bi.

In some embodiments, obtaining the core particle may comprise preparing a precursor comprising transition metal oxide, obtaining the precursor as a pellet, heat-treating the pellet, and cooling and pulverizing the heat-treated pellet.

In one example embodiment, the precursor may further comprise lithium oxide.

In one example embodiment, the heat-treating of the pellet may be performed at 500 to 800° C.

In some embodiments, the core particle obtained can comprise any material that may provide abundant lithium ions to compensate for lithium-ion loss of the negative electrode material, including the non-limiting examples of any one or more of LizNiO₂, Li₂CuO₂, Li₂NiₓCu_{y}M_{1-y}O₂ (where M is at least one of Fe, Co, and Mn, and x and y are 0<x<1, 0<y<1, x+y<1), Li₅FeO₄, and Li₆CoO₄.

In an embodiment of the present disclosure, the precursor may comprise Li₂O and/or NiO. In a further example embodiment, after the precursor is obtained as a pellet by rolling, the pellet may be heat-treated at 500 to 800° C., and cooled and pulverized to obtain the core particle.

In such embodiments, the obtained core particle may be lithium nickel oxide LizNiO₂.

According to an embodiment of the present disclosure, the coating material may be obtained from a mixture comprising C₂H₅OLi and NH₄VO₃. According further example embodiments, in the mixture, C₂H₅OLi and NH₄VO₃ may be included in a molar ratio of 1:2.8-3.2, respectively.

In one example embodiment, the mixture may further comprise Nb(OC₂H₅)₅.

According further example embodiments, in the mixture, C₂H₅OLi, NH₄VO₃, and Nb(OC₂H₅)₅ may be included in a molar ratio of 1:2.8-3.2:0.1-0.4, respectively.

In such embodiments, the mixture may be added to anhydrous ethanol and stirred.

In some embodiments, the obtained coating portion may comprise a compound represented by Chemical Formula 2.

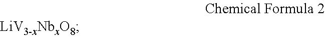

wherein (x is 0≤x≤0.4)

In embodiments, the coating of the coating material on the surface of the core particle may comprise stirring the core particle and the coating material.

According to an embodiment of the present disclosure, the core particle and the coating material may be stirred at 70 to 90° C. and 250 to 350 rpm. In such embodiments, the anhydrous ethanol used to obtain the coating material may be removed.

In another aspect, the disclosure relates to a positive electrode active material that may be manufactured according to a method for manufacturing as described herein.

In an example embodiment, the positive electrode active material may comprise a core portion comprising lithium metal oxide, and a coating portion formed on the surface of the core portion.

In such embodiments, the positive electrode active material may comprise the core particle, as described herein, as the core portion, and the coating material, as described herein, as the coating portion.

Thus, in some embodiments, the core portion may comprise any of Li₂NiO₂, Li₂CuO₂, Li₂NiₓCu_{y}M_{1-y}O₂ (wherein Mis at least one of Fe, Co, and Mn, and x and y are 0<x<1, 0<y<1, x+y<1), Li₅FeO₄, and/or Li₆CoO₄.

In embodiments, the core portion may have an orthorhombic crystal structure.

In some embodiments, the coating portion may comprise a compound of Chemical Formula 1.

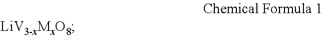

wherein x is 0≤x≤1.5, and M is at least one element of Nb, Ta, Cr, As, Mo, Sb, and/or Bi.

In embodiments, the coating portion may have a monoclinic crystal structure.

In one example embodiment, the coating portion may be obtained from a mixture comprising C₂H₅OLi, NH₄VO₃, and Nb(OC₂H₅)₅.

In such embodiments, the obtained coating portion may comprise a compound of Chemical Formula 2.

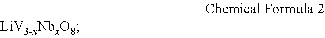

wherein x is 0≤x≤0.4.

In conventional commercialized positive electrode active materials that comprise a large amount of lithium ions, there can be a disadvantage wherein impurities form on the surface by reacting with moisture or carbon dioxide when exposed to air.

In contrast, the positive electrode active material according to embodiments of the disclosure can exhibit excellent air stability which is provided at least in part by the coating portion on the surface of the core portion that comprises a large amount of lithium ions. Accordingly, the formation of impurities such as residual lithium may be suppressed, and reduce side reactions with the electrolyte. In addition, the coating portion according to the present disclosure has excellent ionic conductivity and electronic conductivity, which can reduce the interfacial resistance of the positive electrode active material comprising the core portion and provide for excellent electrochemical characteristics.

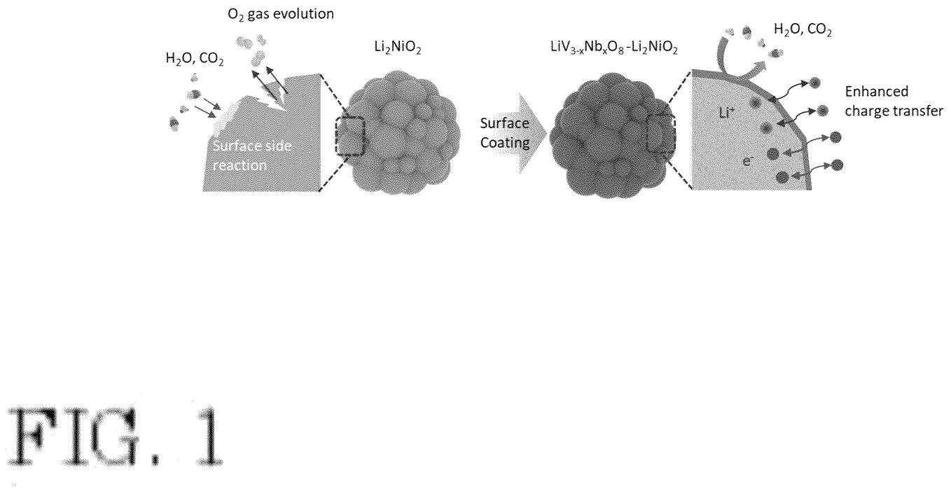

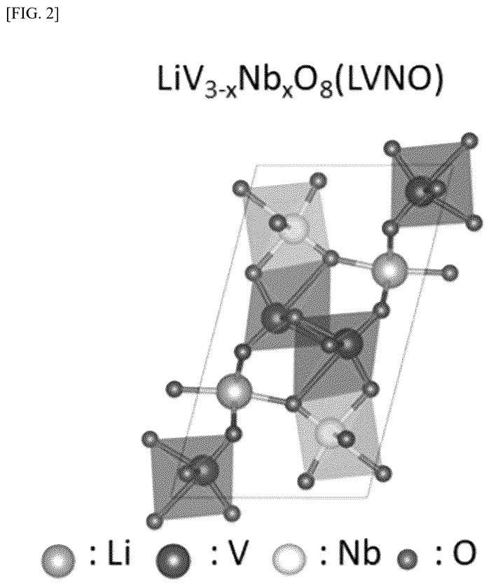

In one example embodiment, the positive electrode active material comprises Li₂NiO₂ as the core portion and LiV₃₋ₓNbₓO₈ (where 0≤x≤1.5) as the coating portion. Embodiments of such a positive electrode active material is schematically shown in FIG. 1, and the chemical structure of the material included in the coating portion is schematically shown in FIG. 2.

The positive electrode active material according to an embodiment of the present disclosure may comprise the coating portion in an amount of 0.1 to 10 wt % based on the total weight of the positive electrode active material.

Without being limited by theory, it may be that when the coating portion is included in more than the above range, the surface of the positive electrode active material may not be uniformly coated, thereby deteriorating electrochemical characteristics. Similarly, it may be that when the coating portion is included in less than the above range, the effects of securing air stability and reducing interfacial resistance may not be improved or achievable.

Accordingly, embodiments comprising the coating portion in the above range, provide for the coating portion to be uniformly coated on the surface of the core portion.

In some preferred embodiments, the coating portion may be included in an amount of 3 wt % to 5 wt % based on the total weight of the positive electrode active material.

As schematically described above and in FIG. 1, the positive electrode active material according to an embodiment of the present disclosure may comprise LizNiO₂ as the core portion and LiV₃₋ₓNbₓO₈ (where 0≤x≤1.5) as the coating portion.

In embodiments, the positive electrode active material may show a peak corresponding to V—O bonding in a Raman shift region of 750 to 800 cm⁻¹ in a Raman spectrum, and a peak corresponding to Nb—O bonding in a Raman shift region of 660 to 700 cm⁻¹.

In embodiments, an X-ray Photoelectron Spectroscopy (XPS) spectrum, exhibits a peak corresponding to V⁵⁺ 2p bonding that may appear in a region of 517.5 to 524.9 eV, and a peak corresponding to Nb⁵⁺ 3d bonding that may appear in a region of 207.1 to 209.9 eV.

In an aspect, a positive electrode in accordance with the present disclosure may comprise the positive electrode active material as described herein, a conductive material, and a binder.

In embodiments, the conductive material is not particularly limited and can comprise conductive material that may be generally used in a lithium secondary battery manufacturing process. For example, the conductive material may comprise any one or more of the non-limiting examples of artificial graphite, natural graphite, carbon black, acetylene black, Ketjen black, Denka black, thermal black, channel black, carbon fiber, metal fiber, aluminum, tin, bismuth, silicon, antimony, nickel, copper, titanium, vanadium, chromium, manganese, iron, cobalt, zinc, molybdenum, tungsten, silver, gold, lanthanum, ruthenium, platinum, iridium, titanium oxide, polyaniline, polythiophene, polyacetylene, polypyrrole, or mixtures thereof.

In embodiments, the binder is not particularly limited and can comprise any binder that may be generally used in a lithium secondary battery manufacturing process. For example, the binder may comprise any one or more of the non-limiting examples of polyvinylidene fluoride (PVdF), copolymer of polyhexafluoropropylene-polyvinylidene fluoride (PVdF/HFP), polyvinylacetate, polyvinyl alcohol, polyethylene oxide, polyvinylpyrrolidone, polyvinyl pyridine, alkylated polyethylene oxide, polyvinyl ether, polymethyl methacrylate, polyethyl acrylate, polytetrafluoroethylene (PTFE), polyvinyl chloride, polyacrylonitrile, styrene-butadiene rubber, acrylonitrile-butadiene rubber, fluoroelastomer, ethylene-propylene-diene monomer (EPDM), sulfonated ethylene-propylene-diene monomer, carboxymethyl cellulose (CMC), regenerated cellulose, starch, hydroxypropyl cellulose, tetrafluoroethylene, or mixtures thereof.

The positive electrode active material according to various embodiments described herein may be advantageously included in the positive electrode in accordance with the disclosure in order to secure stability during charging and discharging of the electrode and prevent deterioration of electrochemical characteristics.

In embodiments, the positive electrode active material may serve to reversibly intercalate or deintercalate lithium ions in a voltage range of 0 to 5 V. As this voltage range is merely exemplary of some embodiments, the positive electrode active material may intercalate or deintercalate lithium ions in a voltage range falling outside the recited range.

In an aspect, the disclosure provides a lithium secondary battery comprising a negative electrode, a separator, and the positive electrode according to various embodiments described herein.

The negative electrode and the separator are not particularly limited and can comprise any negative electrode and any separator that finds use in conventional lithium secondary batteries.

The lithium secondary battery in accordance with the present disclosure can comprise the positive electrode active material described herein, which can suppress side reactions, and exhibit either or both of excellent stability and excellent electrochemical characteristics.

Hereinafter, the present disclosure will be illustrated with reference to Examples and Experimental Examples which are provided merely to describe exemplary embodiments of the disclosure in more detail. It will be appreciated that the scope of the present disclosure is not limited in any way by the following Examples and Experimental Examples.

### Example 1

To obtain core particles comprising lithium metal oxide, Li₂O and NiO were prepared as precursors. Then, 1.0 mol of Li₂O and 1.0 mol of NiO were mixed, and maintained at a pressure of 3.5 tons for 5 minutes using a pelletizer to obtain a pellet. The obtained pellet was heated to 710° C. at a rate of 5° C. per minute in a furnace and maintained at the corresponding temperature for 17 hours. Finally, the calcined product was cooled and pulverized to obtain a powdered Li₂NiO₂ core particle (core portion).

To obtain the coating material, C₂H₅OLi:NH₄VO₃:Nb(OC₂H₅)₅ was mixed at a molar ratio of 1:3:0. The mixture was stirred in anhydrous ethanol to obtain a coating material having Chemical Formula of LiV₃O₈. The coating material was mixed with the core particle material such that the coating material was about 3 wt % of the total weight. Thereafter, the core particles and the coating material were stirred at 300 rpm for 1 hour at 80° C. to remove the anhydrous ethanol and further dried. Then the mixture was heated to 500° C. at a rate of 5° C. per minute in a furnace and maintained at the corresponding temperature for 3 hours. A positive electrode active material was manufactured through a cooling and pulverizing process in which the LizNiO₂ core portion was coated with 3 wt % of LiV₃O₈ coating portion.

### Example 2

A positive electrode active material was manufactured in the same manner as Example 1, except that C₂H₅OLi:NH₄VO₃:Nb(OC₂H₅)₅ was mixed in a molar ratio of 1:2.97:0.03 to obtain a coating material. This provides a coating portion comprising a coating material having a Chemical Formula of LiV_{2.97}Nb_{0.03}O₈.

### Example 3

A positive electrode active material was manufactured in the same manner as in Example 1, except that the coating material was mixed with the core particle to be 5 wt % of the total weight.

### Example 4

A positive electrode active material was manufactured in the same manner as Example 3, except that C₂H₅OLi:NH₄VO₃:Nb(OC₂H₅)₅ was mixed in a molar ratio of 1:2.97:0.03 to obtain a coating material. This provides a coating portion comprising a coating material having a Chemical Formula of LiV_{2.97}Nb_{0.03}O₈.

### Comparative Example 1

1.0 mol of Li₂O and 1.0 mol of NiO were mixed, and maintained at a pressure of 3.5 tons for 5 minutes using a pelletizer to obtain a pellet. The obtained pellet was heated to 710° C. at a rate of 5° C. per minute in a furnace and maintained at the corresponding temperature for 17 hours. The calcined product was cooled and pulverized to manufacture a powdered positive electrode active material.

### Comparative Example 2

C₂H₅OLi:NH₄VO₃:Nb(OC₂H₅)₅ was mixed at a molar ratio of 1:3:0, respectively. The mixture was dispersed in an anhydrous ethanol solvent and then stirred at 300 rpm for 1 hour at 80° C. to remove the anhydrous ethanol and dried. Thereafter, the mixture was heated to 500° C. at a rate of 5° C. per minute in a furnace and maintained at the corresponding temperature for 3 hours. A powdered positive electrode active material was manufactured through cooling and pulverizing processes.

### Comparative Example 3

A positive electrode active material was manufactured in the same manner as Comparative Example 2, except that C₂H₅OLi:NH₄VO₃:Nb(OC₂H₅)₅ was mixed in a molar ratio of 1:2.97:0.03, respectively.

The compositions of Examples and Comparative Examples are shown in Table 1.

TABLE 1

| | | Core particle | | | | |
|---|---|---|---|---|---|---|
| | | content based on | Coating material | | | |
| | | total weight of | content based on total | | | |
| | | positive electrode | weight of positive | | | |
| | Core particle | active material | electrode active | Molar ratio of coating material precursor | | |
| | (core portion) | (wt %) | material (wt %) | C₂H₅OLi | NH₄VO₃ | Nb(OC₂H₅)₅ |
| Ex. 1 | Li₂NiO₂ | 97% | 3% | 1 | 3 | — |
| Ex. 2 | Li₂NiO₂ | 97% | 3% | 1 | 2.97 | 0.03 |
| Ex. 3 | Li₂NiO₂ | 95% | 5% | 1 | 3 | — |
| Ex. 4 | Li₂NiO₂ | 95% | 5% | 1 | 2.97 | 0.03 |
| Com. Ex. 1 | Li₂NiO₂ | 100% | — | | | |
| Com. Ex. 2 | — | — | 100% | 1 | 3 | — |
| Com. Ex. 3 | | | 100% | 1 | 2.97 | 0.03 |

### Experimental Example 1

### Morphology Analysis

In these experiments, the morphologies of the positive electrode active materials of Examples 1 to 4 and Comparative Examples 1 to 3 were analyzed using the following analytical methods.

### X-Ray Diffraction (XRD)

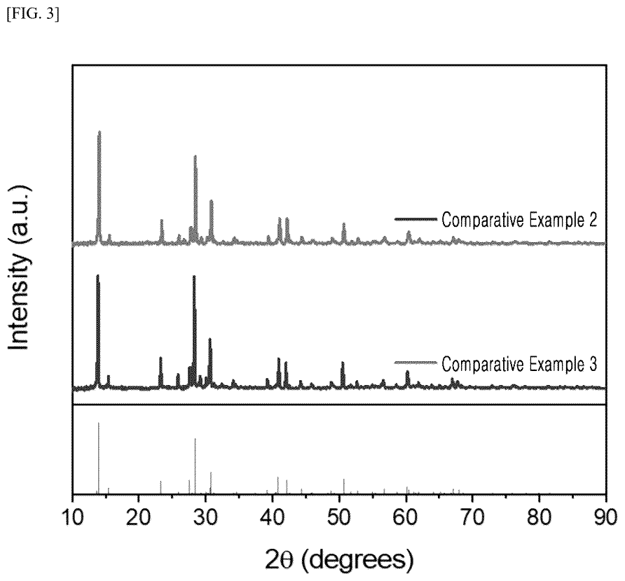

FIG. 3 shows results of X-ray diffraction analysis for Comparative Examples 2 and 3.

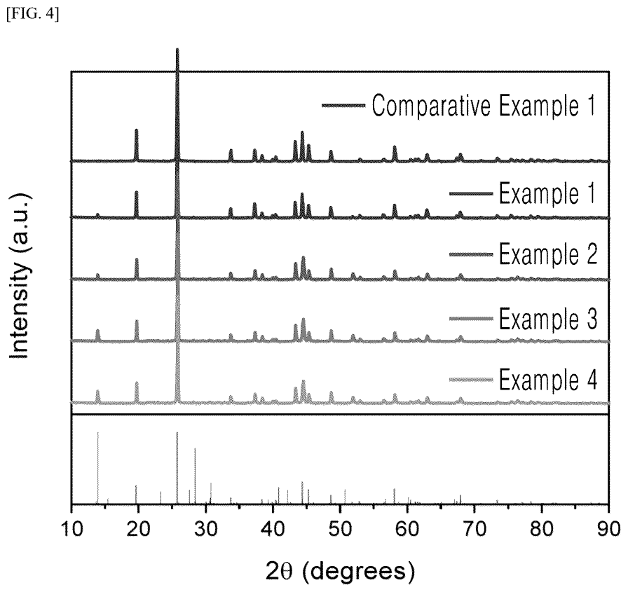

FIG. 4 shows results of X-ray diffraction analysis for Comparative Example 1 and Examples 1 to 4.

Referring to FIG. 3, a peak corresponding to a crystal structure (P21/m, monoclinic) of conventional LiV₃O₈ may be confirmed in Comparative Example 2. Comparative Example 3 also showed the same X-ray diffraction analysis results as Comparative Example 2, and it may be seen that no additional impurities or secondary phases were formed.

Referring to FIG. 4, in Comparative Example 1, a peak corresponding to a crystal structure (Immm, orthorhombic) of conventional Li₂NiO₂ may be confirmed, and Examples 1 to 4 may also show the same X-ray diffraction analysis results as Comparative Example 1. In the case of Examples 1 to 4, a peak corresponding to a crystal structure (P21/m, monoclinic) of LiV₃O₈ due to the introduction of the coating material may be confirmed together.

The data confirms that the core particle and coating material were able to be prepared as intended in each of Examples and Comparative Examples.

### Raman Spectrum

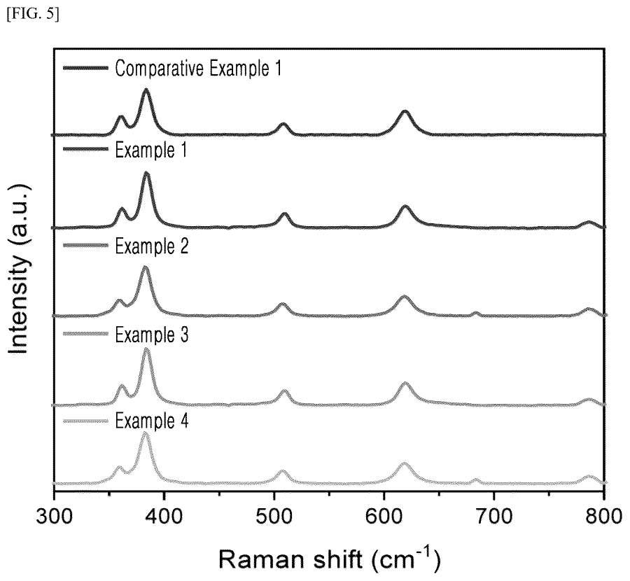

FIG. 5 shows results of Raman spectrum analysis for Comparative Example 1 and Examples 1 to 4.

Referring to FIG. 5, in the case of Examples 1 and 3, peaks may be confirmed in a Raman shift region near 780 cm⁻¹. This is due to the V—O bonding caused by the presence of the coating material, indicating that the coating materials were successfully formed in Examples 1 and 3.

For Examples 2 and 4, it may be confirmed that peaks coexist in the Raman shift region around 780 cm⁻¹ and around 680 cm⁻¹. This is due to the V—O and Nb—O bonds caused by the presence of the coating material, indicating that the coating materials were successfully formed in Examples 2 and 4.

### X-ray Photoelectron Spectroscopy (XPS)

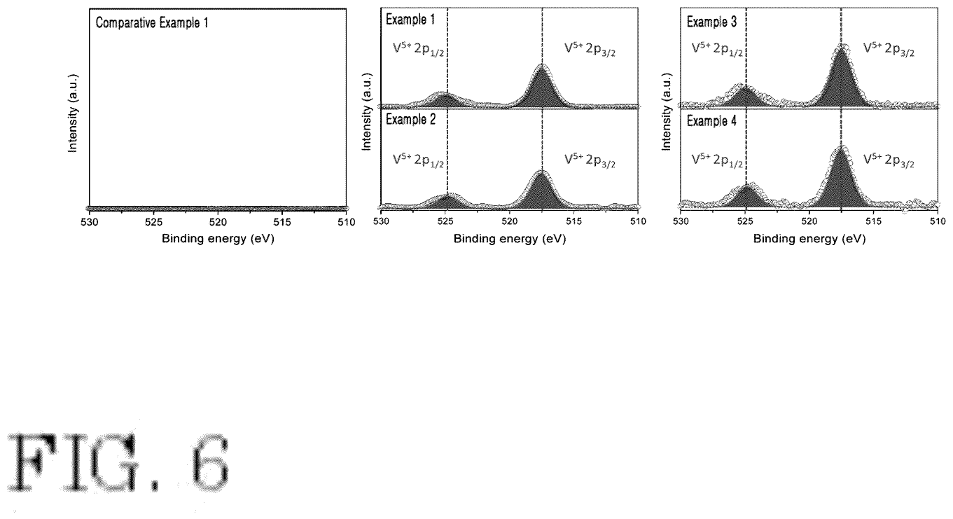

FIG. 6 shows results of X-ray photoelectron spectroscopy (XPS) analysis for V 2p regions of Comparative Example 1 and Examples 1 to 4.

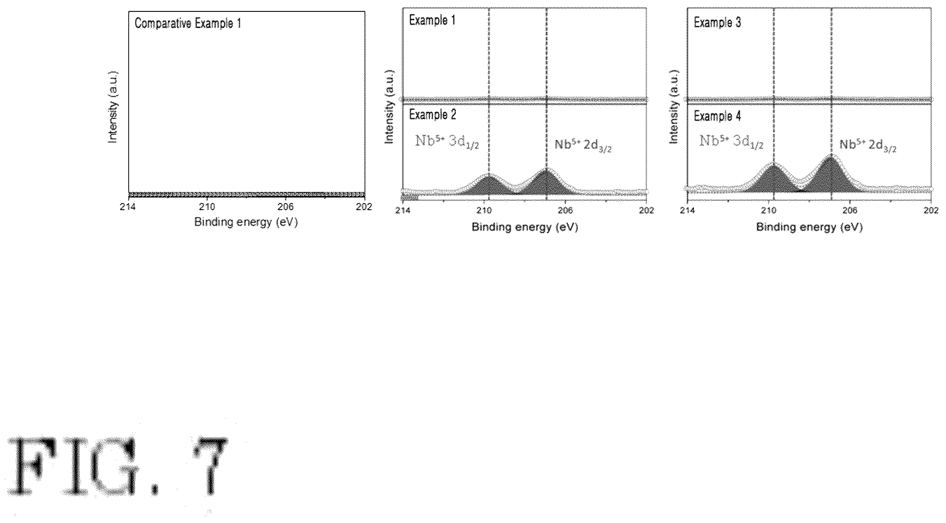

FIG. 7 shows results of X-ray photoelectron spectroscopy (XPS) analysis for Nb 3d regions of Comparative Example 1 and Examples 1 to 4.

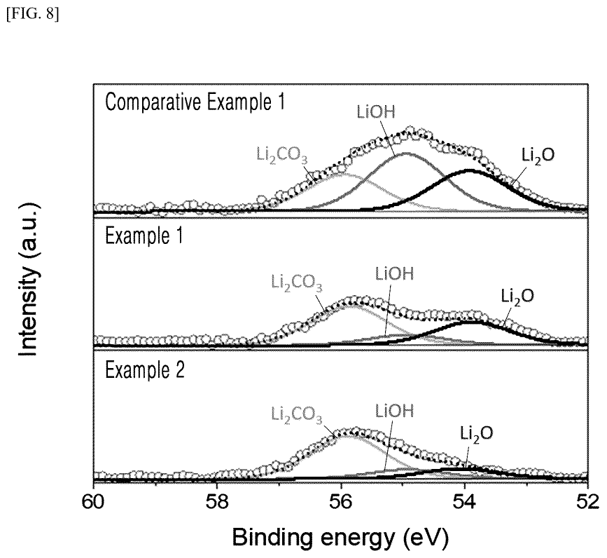

FIG. 8 shows results of X-ray photoelectron spectroscopy (XPS) analysis for Li 1s regions of Comparative Example 1 and Examples 1 and 2.

Referring to FIG. 6, relative to Comparative Example 1, Examples 1 to 4 show peaks corresponding to V⁵⁺ 2p_{1/2} (517.5 eV) and V⁵⁺ 2p_{3/2} (524.9 eV) bonds, which indicate that the coating material was successfully formed.

Referring to FIG. 7, relative to Comparative Example 1, Examples 2 and 4 show peaks corresponding to Nb⁵⁺ 3d_{1/2} (207.1 eV) and Nb⁵⁺ 3d_{1/2} (209.9 eV) bonds which can be attributed to the presence of the coating material, (i.e., Nb is introduced into the crystal structure of the coating portion, indicating that the coating material was successfully formed from the precursor material comprising Nb).

Referring to FIG. 8, relative to Comparative Example 1, Examples 1 and 2 show that the intensities of the peaks corresponding to residual lithium (LiOH) and unreacted lithium (Li₂O) were decreased. This indicates that the positive electrode active materials of Examples 1 and 2 have significantly reduced reactions with moisture or carbon dioxide in air due to the coating portion.

### Scanning Electron Microscopy (SEM)—Energy Dispersive Spectroscopy (EDS)

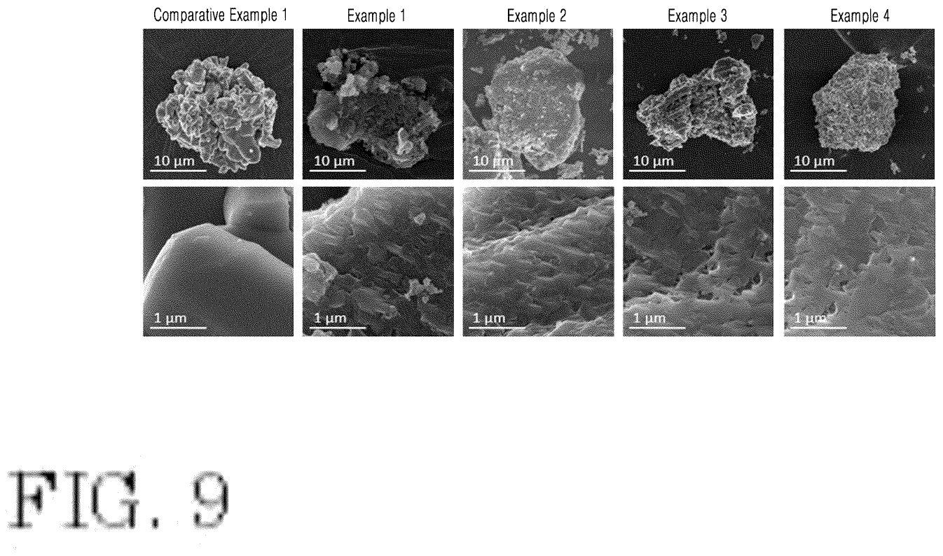

FIG. 9 shows SEM images of Comparative Example 1 and Examples 1 to 4.

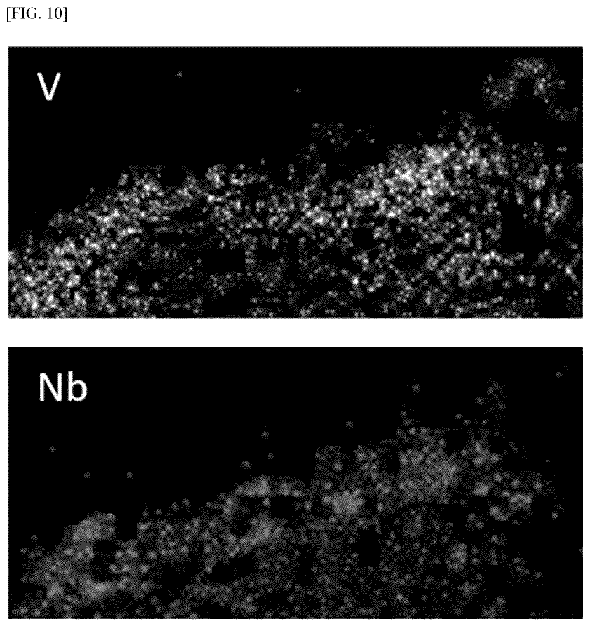

FIG. 10 shows an EDS mapping image for Example 2.

Referring to FIG. 9, the data indicates that the coating material is uniformly introduced to the surface of each of Examples 1 to 4 when compared to Comparative Example 1 which lacks an additional coating portion.

In addition, through the EDS mapping image of FIG. 10, it was confirmed once again that both V and Nb elements were uniformly distributed on the surface of the positive electrode active material of Example 2.

### Transmission Electron Microscopy (TEM)

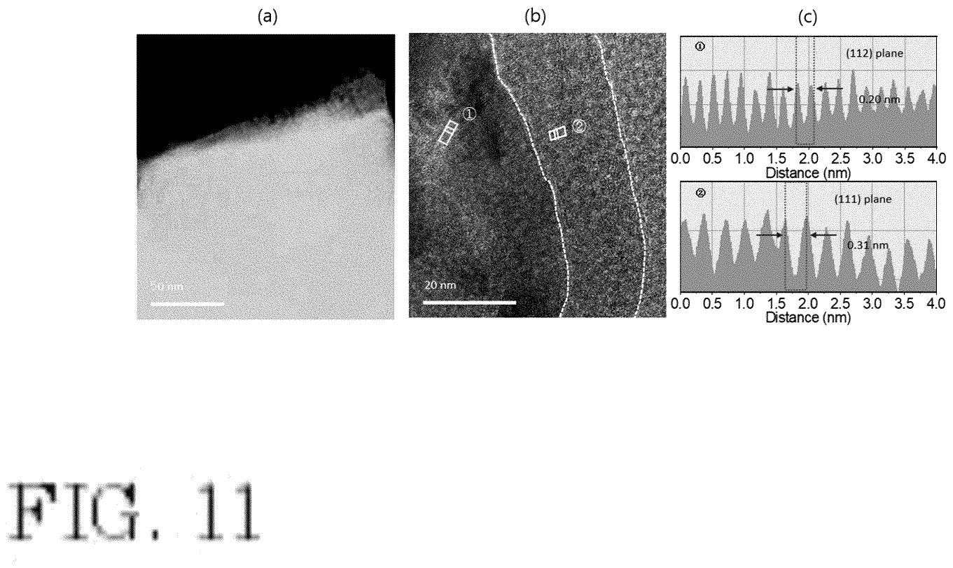

FIG. 11 shows a TEM image of a positive electrode active material of Example 2 and analysis results of an interplanar distance calculated based on the TEM image. FIG. 11A is a TEM image of Example 2 observed at a relatively low magnification, FIG. 11B is a TEM image of Example 2 observed at a relatively high magnification, and FIG. 11C is a result of measuring the interplanar distance between a core portion and a coating portion based on FIG. 11B.

Through FIG. 11, the presence of the core portion and the coating portion included in the positive electrode active material of Example 2 was confirmed, and the interplanar distances between the core portion Li₂NiO₂ and the coating portion LiV₃O₈ (specifically, LiV_{2.97}Nb_{0.03}O₈) were measured to be 0.20 nm and 0.31 nm to have (112) and (111) planes, respectively.

### Experimental Example 2

### Evaluation of Electrochemical Characteristics

In these experiments, electrodes comprising the positive electrode active materials of the Examples and Comparative Examples were manufactured to evaluate the electrochemical characteristics. First, a carbon black conductive material, a carbon-based active material, and polyvinylidene fluoride (PVdF) were mixed in a weight ratio of 93:3:1:3, respectively. Thereafter, the mixture was mixed with the positive electrode active material according to the Examples and Comparative Examples, and a slurry was prepared using N-methylpyrrolidone (NMP) as a solvent. The prepared positive electrode slurry was coated on aluminum foil with a thickness of 50 μm, dried, and then roll-pressed and dried at 120° C. for 12 hours in a vacuum to manufacture an electrode.

A coin cell was manufactured using a solution in which 1 mol of LiPF₆ was dissolved in a solvent of ethylene carbonate (EC) and ethyl methyl carbonate (EMC) that were mixed at a volume ratio of 1:2 as an electrolyte, together with the electrode.

In order to evaluate the electrochemical characteristics, the charge and discharge voltage range for the manufactured cell was set to 3.0 to 4.3 V, and charge and discharge were performed at a rate of 0.2 C and 0.2 C, respectively. (1.0 C=320 mA/g)

Hereinafter, references to Examples 1 to 4 and Comparative Examples 1 to 3 will specifically refer to coin cells manufactured with electrodes comprising each positive electrode active material.

### Impedance Analysis

Before evaluating the electrochemical characteristics, impedance was measured for Comparative Example 1 and Examples 1 to 4.

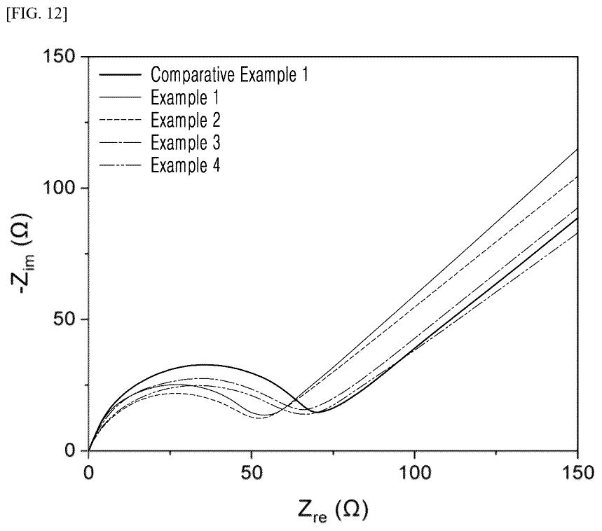

The results are shown in FIG. 12 and Table 2 below.

TABLE 2

| | Rₛ (Ω) | R_{ct} (Ω) |
|---|---|---|
| Comparative Example 1 | 3.8 | 78.5 |
| Example 1 | 3.6 | 59.8 |
| Example 2 | 3.5 | 56.3 |
| Example 3 | 3.7 | 66.2 |
| Example 4 | 3.6 | 64.8 |

Rₛ: Ohmic resistance
R_{ct}: Charge transfer resistance, interfacial resistance

Referring to Table 2 and FIG. 12, the data shows that the ionic conductivity is improved in Examples 1 to 4 compared to Comparative Example 1 likely due to the introduction of the coating portion, and the interfacial resistance (R_{ct}) is reduced likely due to the reduction of residual lithium. In addition, in the case of Examples 1 to 4, the ohmic resistance decreased compared to Comparative Example 1, which indicates that the resistance was decreased and the conductivity was improved throughout the cell.

### Capacity Analysis

The capacity during charge and discharge was analyzed for Comparative Example 1 and Examples 1 to 4.

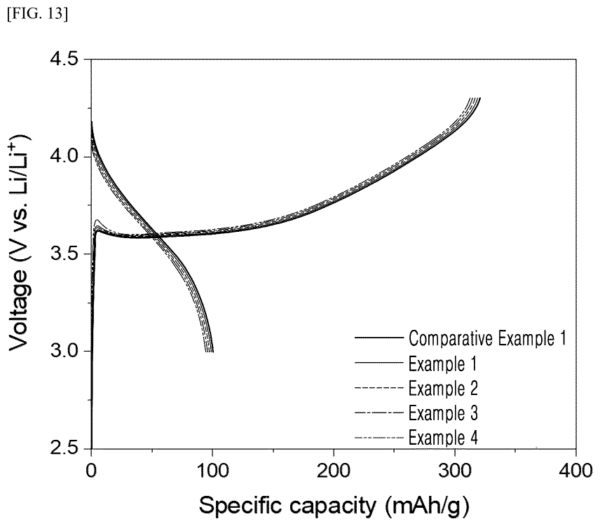

The results are shown in FIG. 13 and Table 3 below.

TABLE 3

| | Charge (mAh/g) | Discharge(mAh/g) |
|---|---|---|
| Comparative Example 1 | 320.2 | 100.0 |
| Example 1 | 317.2 | 97.4 |
| Example 2 | 318.3 | 98.4 |
| Example 3 | 313.3 | 94.6 |
| Example 4 | 315.9 | 95.4 |

Referring to the data in Table 3 and FIG. 13, that Example 1 showed a charge capacity retention rate of about 99.1%, Example 2 showed about 99.4%, Example 3 showed about 97.8%, and Example 4 showed about 98.7%, when based on Comparative Example 1. In addition, Example 1 showed a discharge capacity retention rate of about 97.4%, Example 2 showed about 98.4%, Example 3 showed about 94.6%, and Example 4 showed about 95.4%, when based on Comparative Example 1. This shows that the capacity characteristics are excellent and at least comparable to the performance of a conventional commercialized positive electrode active material, as in Comparative Example 1, even though an additional coating material was introduced in Examples 1 to 4.

### Air Stability Analysis

Air stability was analyzed by leaving Comparative Example 1 and Examples 1 to 4 exposed to air at a relative humidity of 40% for 24 hours.

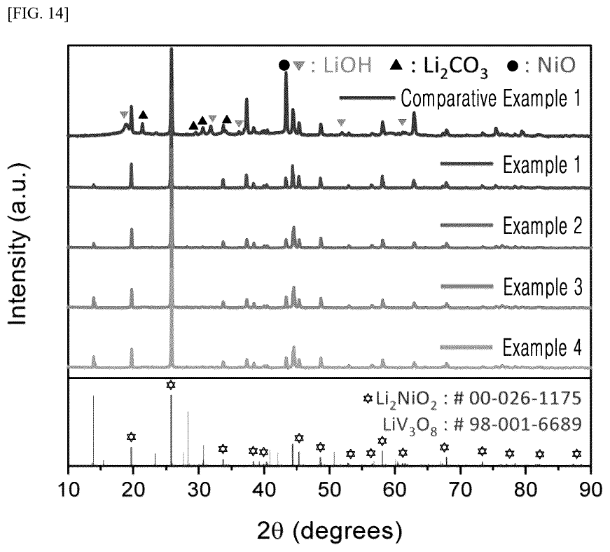

X-ray diffraction analysis results are shown in FIG. 14, and the NiO peak % contents are shown in Table 4 below.

TABLE 4

| | NiO (%) |
|---|---|
| Comparative Example 1 | 62.7 |
| Example 1 | 24.8 |
| Example 2 | 21.6 |
| Example 3 | 25.1 |
| Example 4 | 25.0 |

Referring to FIG. 14 and Table 4, is the data shows no residual lithium (LiOH, Li₂CO₃) peak in Examples 1 to 4 when compared to Comparative Example 1. In addition, the NiO peak contents are greatly reduced in Examples 1 to 4. It appears that the introduction of the coating portion prevents the Li₂NiO₂ core portion from being exposed to the air, thereby suppressing the formation of impurities from air exposure.

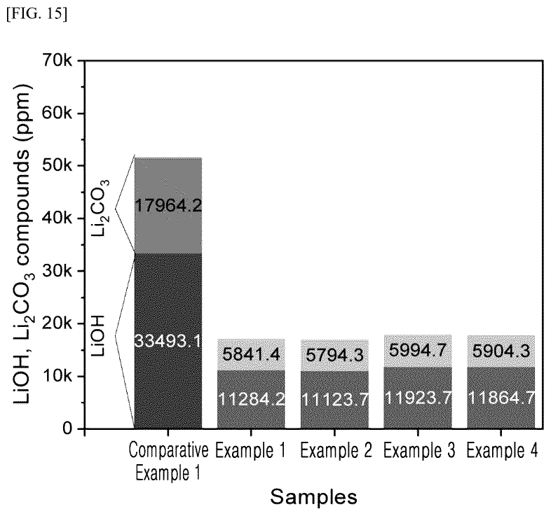

FIG. 15 and Table 5 below show results of measuring residual lithium (LiOH, Li₂CO₃) through electrochemical titration in Comparative Example 1 and Examples 1 to 4 after air exposure for 24 hours at a relative humidity of 40%

TABLE 5

| | LiOH (ppm) | Li₂CO₃ (ppm) |
|---|---|---|
| Comparative Example 1 | 33493.1 | 17964.2 |
| Example 1 | 11284.2 | 5841.4 |
| Example 2 | 11123.7 | 5794.3 |
| Example 3 | 11923.7 | 5994.7 |
| Example 4 | 11864.7 | 5904.3 |

FIG. 15 and Table 5 show that LiOH decreased by 66.3, 66.8, 64.4, and 64.6% in Examples 1 to 4, respectively, compared to Comparative Example 1. Further, Li₂CO₃ decreased by 67.5, 67.7, 66.6, and 67.1%, respectively, compared to Comparative Example 1. It appears that the introduction of the coating portion prevents the Li₂NiO₂ core portion from being exposed to the air, thereby suppressing the formation of impurities from air exposure.

### Gas Generation Analysis

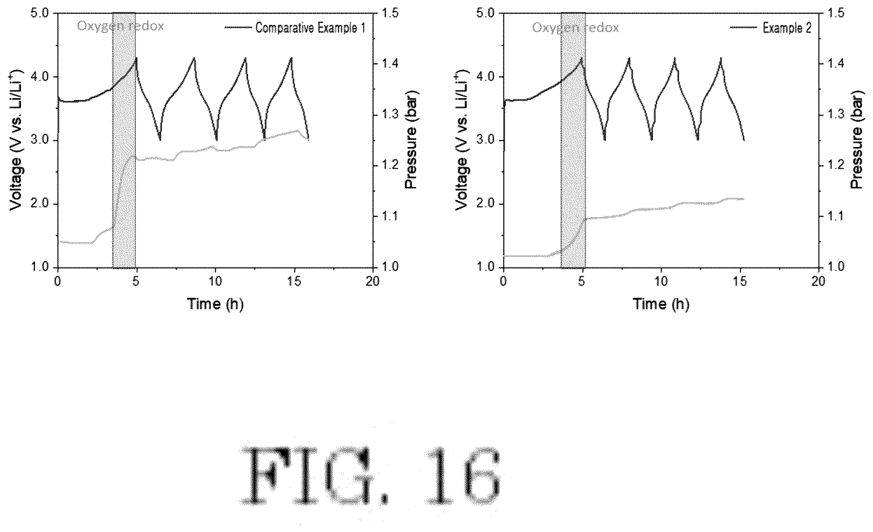

The gas generation amounts were analyzed for Comparative Example 1 and Example 2, and the results are shown in FIG. 16.

FIG. 16 shows that any increase in gas generation amount of Example 2 is smaller than that of Comparative Example 1. As a result of the gas generation analysis, a pressure change due to the generated gas of Comparative Example 1 was 0.22 bar, and a pressure change of Example 2 was measured as 0.11 bar, confirming that the gas generation amount was reduced by 50%. This data confirms that the formation of impurities (e.g., residual lithium) from exposure to air was suppressed by the introduction of the coating portion, and the side reactions between the impurities and the electrolyte were reduced, thereby suppressing gas generation.

The present disclosure has been described with reference to several example preferred embodiments of the aspects and embodiments described herein. It will be understood by those skilled in the art that the present disclosure may be implemented in modified forms without departing from the spirit and scope of the present disclosure. Thus, as noted above, the example embodiments should be considered merely as illustrative not in any way restrictive. The scope of the present disclosure is illustrated by the appended claims in light of the foregoing description, and all equivalents thereof.

1. A method for manufacturing a positive electrode active material comprising:
obtaining a core particle comprising lithium metal oxide;
obtaining a coating material comprising a compound of Chemical Formula 1: 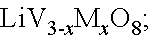
coating the surface of the core particle with the coating material, wherein in Chemical Formula 1, x is 0≤x≤1.5, and M comprises at least one of Nb, Ta, Cr, As, Mo, Sb, and/or Bi.

2. The method of claim 1, wherein the core particle comprises at least one of Li₂NiO₂; Li₂CuO₂; Li₂NiₓCu_{y}M_{1-y}O₂, wherein Mis at least one of Fe, Co, and Mn, and x and y are 0<x<1, 0<y<1, and x+y<1; Li₆FeO₄; and/or Li₆CoO₄.

3. The method of claim 1, wherein the obtaining of the core particle comprises heat-treating a precursor comprising Li₂O and NiO at 500 to 800° C.

4. The method of claim 1, wherein the coating material is obtained from a mixture comprising C₂H₅OLi and NH₄VO₃.

5. The method of claim 4, wherein the mixture comprises C₂H₅OLi and NH₄VO₃ in a molar ratio of 1:2.8-3.2.

6. The method of claim 4, wherein the mixture further comprises Nb(OC₂H₅)₅.

7. The method of claim 6, wherein the mixture comprises C₂H₅OLi, NH₄VO₃, and Nb(OC₂H₅)₅ in a molar ratio of 1:2.8-3.2:0.1-0.4.

8. The method of claim 1, wherein the coating of the coating material on the surface of the core particle is characterized by stirring the core particle and the coating material at 70 to 90° C. and 250 to 350 rpm.

9. A positive electrode active material comprising:
a core portion comprising lithium metal oxide; and
a coating portion formed on the surface of the core portion and comprising a compound of Chemical Formula 1: LiV₃₋ₓMₓO₈, and
wherein x is 0≤x≤1.5, and
M is at least one of Nb, Ta, Cr, As, Mo, Sb, and/or Bi.

10. The positive electrode active material of claim 9, wherein the core portion comprises one of LizNiO₂, Li₂CuO₂, Li₅FeO₄, Li₆CoO₄, and/or Li₂NiₓCu_{y}M_{1-y}O₂, wherein M is one of Fe, Co, and/or Mn, and x and y are 0<x<1, 0<y<1, x+y<1.

11. The positive electrode active material of claim 9, wherein the coating portion is included in an amount of 0.1 to 10 wt % based on the total weight of the positive electrode active material.

12. The positive electrode active material of claim 9, wherein the positive electrode active material is characterized by a Raman spectrum comprising a peak in a shift region of 750 to 800 cm⁻¹, and a peak in a shift region of 660 to 700 cm⁻¹.

13. The positive electrode active material of claim 9, characterized by an X-ray Photoelectron Spectroscopy (XPS) spectrum comprising a peak in a region of 517.5 to 524.9 eV, and a peak in a region of 207.1 to 209.9 eV.

14. The positive electrode active material of claim 9, wherein the positive electrode active material reversibly intercalates or deintercalates lithium ions in a voltage range of 0 to 5 V.

15. A positive electrode comprising:
a positive electrode active material according to claim 9;
a conductive material; and
a binder.

16. A positive electrode comprising:
a positive electrode active material according to claim 10;
a conductive material; and
a binder.

17. A positive electrode comprising:
a positive electrode active material according to claim 11;
a conductive material; and
a binder.

18. A lithium secondary battery comprising a positive electrode according to claim 15.

19. A lithium secondary battery comprising a positive electrode according to claim 16.

20. A lithium secondary battery comprising a positive electrode according to claim 17.
